(19) United States
(12) Patent Application Publication
(10) Pub. No.: US 2002/0064766 A1
(43) Pub. Date: May 30, 2002

(54) Method and apparatus for managing enterprise employee training systems

(76) Inventors: Kerri Cozens, Milpitas, CA (US); Brenda Lobo, San Jose, CA (US); Eugenia Romanovsky, Palo Alto, CA (US); Suzie Wan, South San Francisco, CA (US); Cecilia Wolf, Danville, CA (US); Lawrence J. Hayes, Westwood, MA (US); Frankie Lau, Pleasanton, CA (US); James R. Miller, Los Altos, CA (US); Minerva Tanglao, San Jose, CA (US)

Correspondence Address: The Hecker Law Group, Suite #2300, 1925 Century Park East, Los Angeles, CA, 90067, US

(21) Appl. No.: 09/861,199

(22) Filed: May 17, 2001

Related U.S. Application Data
(60) Provisional application No. 60/205,764, filed on May 19, 2000.

(51) Int. Cl. G09B 3/00

(52) U.S. Cl. 434/350

(57) ABSTRACT

The present invention comprises a method and apparatus for managing an enterprise employee training system. For example, classes can be defined, registered for, delivered, managed, and tracked across a global intra-company network. The system supports management of classes that are given in classrooms, broadcast by satellite, delivered on books or videotapes, given as collaborative web-based classes, or offered as self-paced classes given over a network, by book or by video. The system correctly interfaces with a multi continental workforce that speaks multiple languages, works a varied calendar in multiple time zones, travels between work locations, and has regional training requirements in multiple continents. Tracking of student registration and class participation as well as other processes are used by the system to allow billing and management decisions about employee training to be uniformly propagated throughout the system. The system also provides for system interfaces in multiple continents and in multiple languages. A common user-interface and a single point of maintenance are also features and reduce user training, documentation, and management costs. Thus, the present invention presents a global solution for large companies to manage a global employee-training program by providing a centralized database, automated fault-tolerant notification, and flexible HTML-based user interfaces.

This non-provisional application takes priority from U.S. Provisional Application No. 60/205,764 filed on May 19, 2000.

### BACKGROUND OF THE INVENTION

1. Field of the Invention

This invention relates to the field of computer software and data processing, and more particularly to a method and apparatus for managing enterprise employee training systems.

2. Background

Technology continues to evolve and becomes more complex over time. In the course of a single career, technology can antiquate an employee's skills. As a company grows, the need to train existing employees in new and changing technologies is critical to the success of the company. Modern companies must therefore strive to keep a stable and well-trained workforce. Many companies go about doing this by implementing a company wide employee-training program. However, for large companies, with many thousands of employees, managing employee training can be a daunting task that is fraught with complexity.

Enterprise Employee Training

Keeping a workforce up to date requires human resource departments and company management to constantly monitor, evaluate, and modify the constantly change and modify the computer system tasked with management of the training program. For enterprise companies, which are companies with thousands of employees stationed at sites around the world, a system to manage employee training must perform on a global scale.

One problem faced by large companies is that it is difficult to effectively manage the number of employees that must be trained while still enforcing the constraints placed upon such training by company needs. Moreover, it is difficult to make the system widely accessible to employees that speak different languages and reside in different parts of the world. Thus, there is a need for an enterprise employee training system that enforces the rules established by management but that is still directly accessible by employees. Such a system would benefit the company because it would reduce the overall costs associated with managing and maintaining the system

The user interface should be flexible enough to work well in multiple languages, and be easily customized to meet the regional requirements of each division within the company. In the past, such interfaces were generally written as graphical user interface computer programs. Such programs required programmers to rewrite the interface programs to reflect changing information and to meet the needs of different regional offices of the corporation. Thus, there is a need for a user interface to the system that easily changes according to the language requirements of the user.

Systems supporting large companies must handle many thousands of transactions per year, and generate useful reports to aid management decisions about training. In addition, such systems should manage classroom allocation, manage training products, handle in-house and external billing and chargebacks, track employee training history, and be easy to access while ensuring the security required of a global database.

Available commercial registration systems are not designed to work on a global scale. It would be desirable for such systems to provide support for a global training plan while allowing localized customization of the information in the system.

An additional limitation of existing commercial training system is that they are not scalable to the needs of very large companies. Small companies may use a single computer to run their database, authentication, and accounting servers. In very large companies, these functions often run on different and often remote computers. Thus large companies often require interfaces between multiple servers to occur on a scheduled, not an on-demand, basis. Existing systems do not offer the flexibility required for enterprise corporations to easily interface to multiple other in-house computer systems.

Automation is also a critical requirement in an enterprise employee training system. With thousands of employees requiring services from such a system, the overhead required to run a training program may become unmanageable. Functions that can be performed by the system on a scheduled basis can save many employee-hours and therefore reduce the cost of the training system. Available systems do not provide the level of reliable automation required to keep the cost of managing an enterprise employee training system contained.

To add further complication, the method of delivering education to employees is constantly changing. While tradition dictates gathering students for classroom lectures, many new methods of communication are now available for employee education. Existing educational management systems are not designed to manage a multitude of course delivery methods, or to be extensible to methods not yet devised.

Thus, there is a need for a system that allows large companies to meet many varied requirements for managing an enterprise employee-training system on a global scale.

### SUMMARY OF THE INVENTION

One embodiment of the present invention comprises a method and apparatus for managing an enterprise employee training system where classes are defined, registered for, delivered, managed, and tracked across a global intra-company network. The system provides facilities to allow a company to efficiently manage all aspects of an employee-training program.

Modern large global companies perform employee training through a multitude of class delivery formats. One embodiment of the present invention supports management of classes that are given in classrooms, broadcast by satellite, delivered on books or videotapes, given as collaborative web-based classes, or offered as self-paced classes given over a network, by book or by video. While one embodiment of the present invention is implemented on a global intranet, a person of ordinary skill in the art will see that this invention could be implemented on any form of interconnection fabric.

A system designed to manage enterprise employee training should correctly interface with a workforce that speaks multiple languages, works a varied calendar in multiple time zones, travels between work locations, and has regional training requirements in multiple continents. Such enterprise systems must typically be centrally controlled so that management decision about employee training may be uniformly propagated throughout the system. For enterprise systems, a common user-interface and a single point of maintenance are highly desirable features. Such features reduce user training, documentation, and management costs. One embodiment of the present invention provides all these advantages through one method and apparatus. With a centralized database, automated fault-tolerant notification, and flexible HTML-based user interfaces, present invention provides a global solution for large companies to manage a global employee-training program.

### BRIEF DESCRIPTION OF THE DRAWINGS

FIG. 1 illustrates the overall system architecture of one embodiment of the invention.

FIGS. 2A and 2B illustrate the relationship between the objects used to implement one embodiment of the present invention.

FIG. 3 provides an example of a general-purpose computer to be used with one embodiment of the present invention.

FIG. 4A illustrates an overview of the process used by one embodiment of the invention of class lifecycle from definition to billing.

FIG. 4B illustrates the database record definitions required by one embodiment of the invention to define a class.

FIG. 5 illustrates the process of student registration as it occurs in one embodiment of the invention.

FIG. 6 illustrates the process used by one embodiment of the invention to manage class cancellation.

FIG. 7 illustrates the process used by one embodiment of the invention to manage pre-class and post-class record processing.

FIG. 8 illustrates the process used by one embodiment of the invention to process classes accounting records for product-based classes.

FIG. 9 illustrates the HTML Builder functionality in one embodiment of the present invention.

FIG. 10 illustrates the HTML page generation process in one embodiment of the invention.

### DETAILED DESCRIPTION OF THE INVENTION

A method and apparatus for managing an enterprise employee training system is described. One embodiment of the present invention comprises a method for managing the data required to implement an enterprise employee training system. In the following description, numerous specific details are set forth in order to provide a more through description of one embodiment of the present invention. It will be apparent, however, to one skilled in the art, that the present invention may be practiced without these specific details. In other instances, well-known features have not been described in detail so as not to obscure the invention.

The term “class” and “course” may be used in this description in the sense that a class comprises an instance of a course. For example, a course catalog may describe courses offered by an educational department or institution, but a class schedule is required to know which courses are being offered in any given session. A course may comprise a title, description, and prerequisites, while a class typically has a course number, time, instructor, and location.

### System Overview

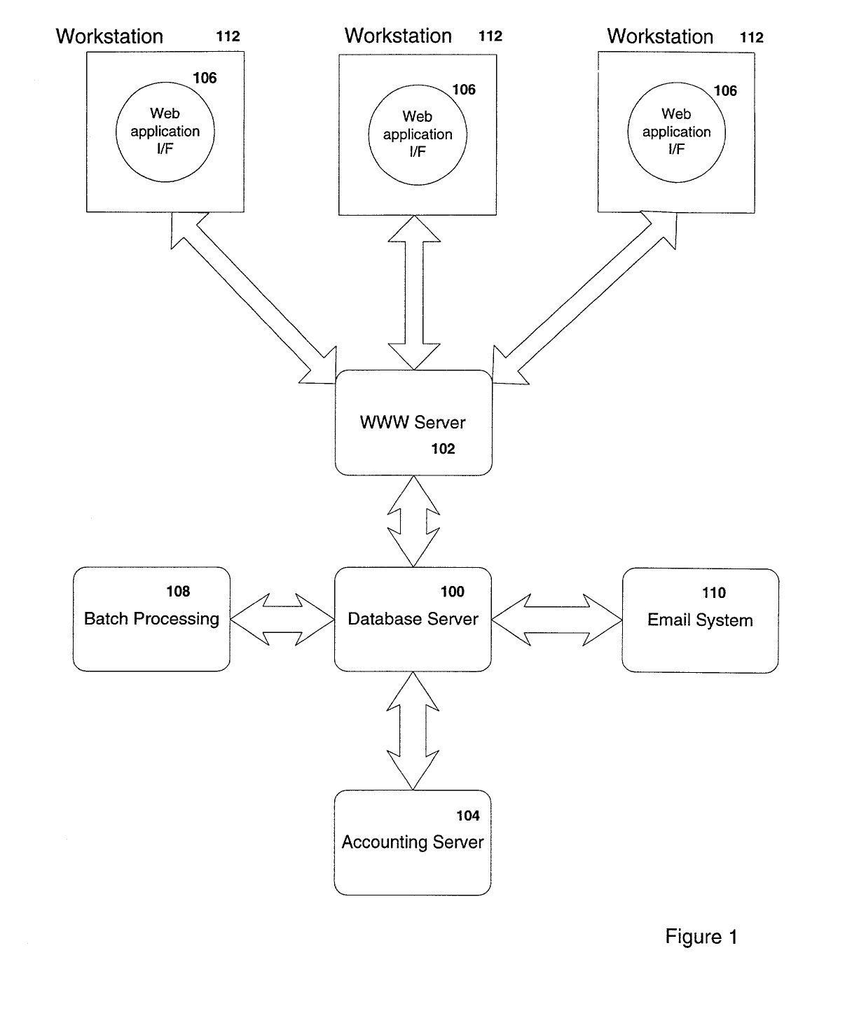

The architectural elements that may be used to implement one embodiment of the present invention include a database server, a WWW server, a network, and one or more user workstations. As shown in FIG. 1, database server 100 comprises a computer system running a commercial database engine of sufficient computing power and storage capacity to sustain many thousands of transactions per year. WWW server 102 may be any extensible commercial web server framework. In one embodiment of the invention, the JavaWebServer™ made by Sun Microsystems, Inc. is used. However, the invention contemplates the use of other extensible web server frameworks. Servers 100 and 102 may execute on the same or on different computers in the network. All elements of one embodiment of the present invention may be connected by any interconnection fabric, including the Internet or any other type of network, to form a communications link between users and the enterprise educational training system. Users of the system may include students, instructors, administrators, managers, administrative assistants, vendors, new hires and others.

Software elements of the system may include web application interface 106, which may run on any number of client devices 112. Client devices 112 may be networked in any conventional fashion to WWW server 102. Client device 112 may be a workstation, personal computer, or any other device capable of accessing one embodiment of the present invention via an interconnection fabric. Additional software elements of the system include extensions to WWW server 102, extensions to database server 100, batch processing 108, and software configured to interface with accounting server 104. In one embodiment of the invention, administrator tools and system maintenance tools are additional software elements of the invention.

The hardware architecture of one embodiment of the present invention assumes, in general, that data is stored and managed on database server 100, and that WWW server 102 is the user's only interface to database server 100. Users gain a view into the system using client device 112 and web application interface 106. In one embodiment of the present invention, web application interface 106 is generally a web browser. The user navigates locally on client device 112 and data is requested by web application interface 106 from database server 100 via WWW server 102 as necessary. This arrangement of client, web server, and database server is a typical three-tier architecture that provides enhanced database security, and is well known to those of ordinary skill in the art.

Functional Elements

According to an embodiment of the present invention, the system is composed of the following functional components: the course component, the class component, the registration component, the request component, the class products component, the miscellaneous administrative maintenance component, the database component, the batch processing component, and the notification and email component. Each of these functional components is responsible for different aspects of the overall employee training management system.

FIG. 1 illustrates the functional components used by an embodiment of the invention to manage enterprise employee training. Database server 100, WWW server 102, and email system 110 are commercially available programs customized by one embodiment of the present invention to meet the needs of an enterprise employee training system. An embodiment of the present invention interfaces with accounting server 104. In one embodiment of the present invention, web application interface 106 is developed as a set of one or more HTML web pages. However, web application interface 106 may comprise other types of documents that are capable of being disseminated through a computer network in other embodiments of the invention. These web pages are sent to client device 112 by WWW server 102, and they act as web application interface 106. One embodiment of the present invention includes a batch processor that is described in more detail below. An embodiment of the invention contemplates building extensions to database server 100 and WWW server 102. All the elements of one embodiment of the present invention described herein should be built in a scalable manner to meet the needs of an expanding large company or enterprise corporation.

An embodiment of the invention comprises one or more customized software programs. Such programs include, but are not limited to, the web server extensions, the request handler, the notification handler and the batch processor programs. Administrative tools such as the administrator's search handler and the HTML interface builder are also software elements of one embodiment of the present invention system that are described herein as part of one embodiment of the invention.

Overview of Course Definition and Maintenance

The process of defining and managing a training course utilizing the method of one embodiment of the present invention is illustrated below. In an embodiment of the present invention, training courses are described on two levels. Courses are first defined at the global (international) level. This feature of the method allows the corporation control of its overall education program. In one embodiment of the invention, the corporation may enact an approval cycle for course definitions before allowing a global course to be instantiated in the system. Access to the system to define a global course can be restricted to a certain class of user to provide additional control over what courses are offered to employees.

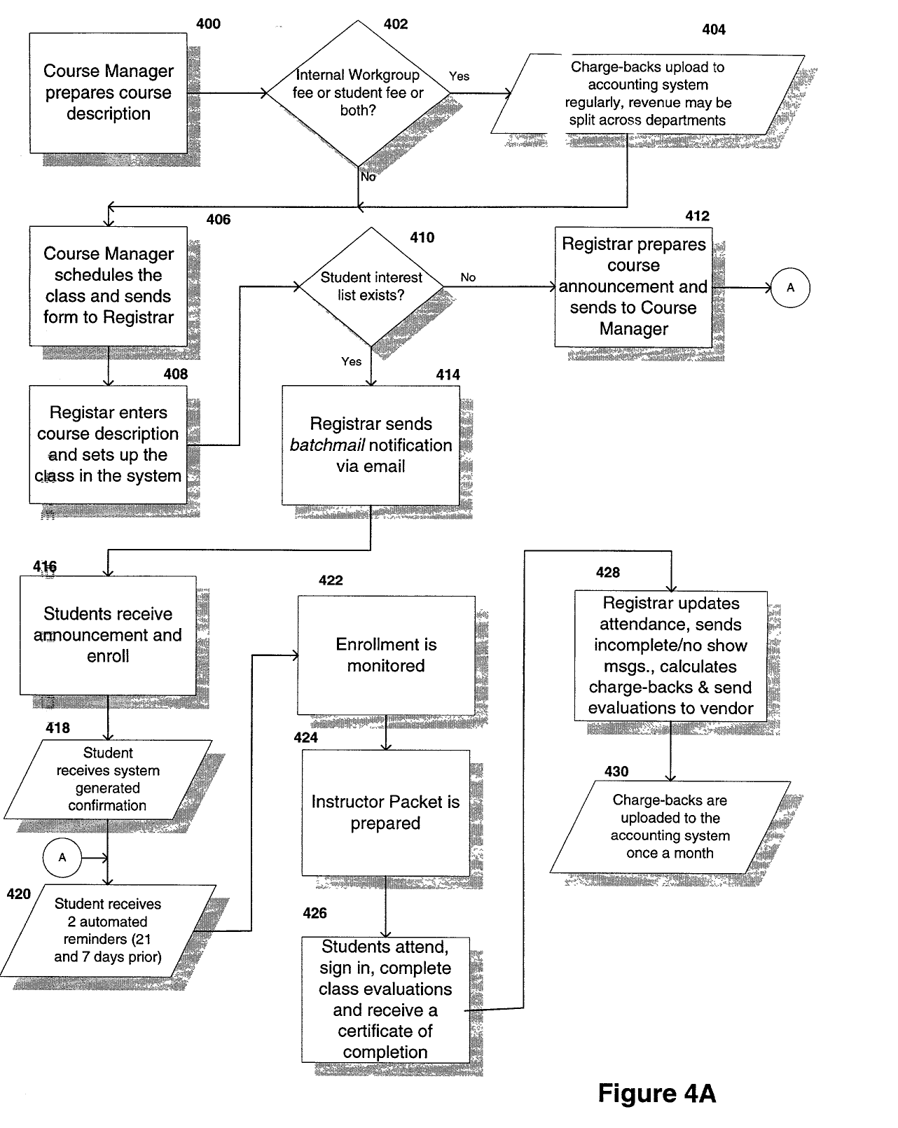

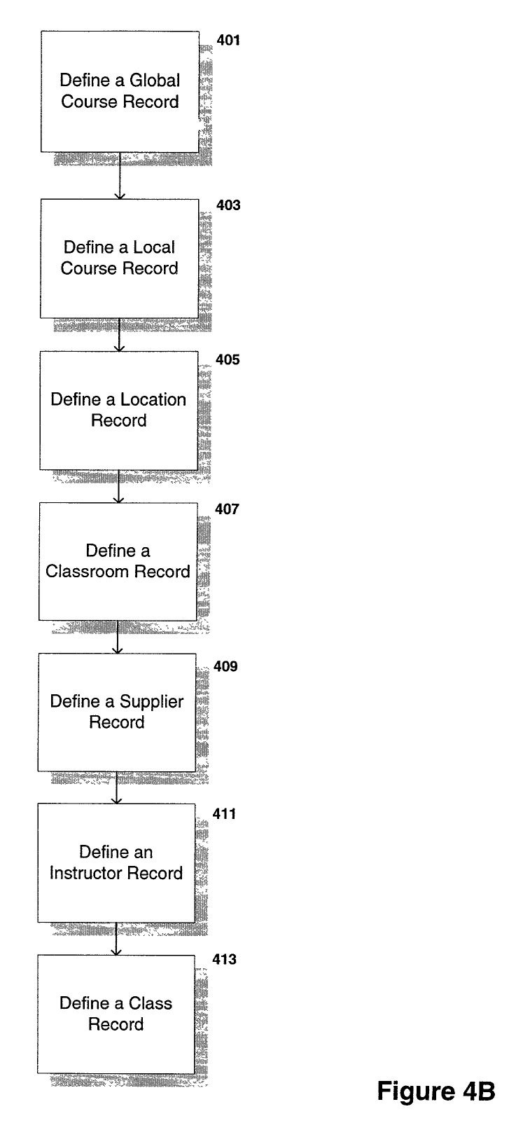

FIG. 4A provides an overview of the lifecycle of a course in one embodiment of the present invention. The process starts at step 400, where a course manager, an employee with authority to define a course in the system, prepares a course description. At step 402 it is determined whether the course fee is an internal workgroup fee, a student fee, neither, or both. If the answer is neither (e.g. there is not fee for the course) then flow proceeds to step 406. If the course is an internal workgroup course, or there is a student fee, or both, step 404 ensures that the correct accounting procedures are set up for the course revenue and charge-backs. For internal workgroup courses, charges may be split across departments. For example, if an employee from one department obtains permission to attend an internal workgroup course offered for another department, then two departments may be billed for the course. In addition, the instructor may come from a third department, and the revenue of the course will need to be allocated to a third department. Finally, any course may or may not charge a student fee, and the accounting records should be set up accordingly. Course charges can be adjusted at the local course level as required.

At step 406, the course manager schedules the course and sends an information form about the course to the registrar. At step 408 the registrar enters a course description and sets up the class in the system. The registrar is an employee with permission to define and change records in the computer system of the invention. FIG. 4B demonstrates the process of defining a course in one embodiment of the present invention. In first step, the registrar defines global course record 401 in the system, and sets up a class description. A student interest list for the class may already exist, as tested in step 410. If there is no student list the registrar prepares a course announcement in step 412 and sends it to the course manager, and the method proceeds to step 420. If a student interest list exists at the time of course definition, then in step 414 the registrar may inform the students on the interest list by sending them email, via the batch processor, to notify them that the class will be held. Course and class records may be entered from multiple continents and in multiple languages.

After the course and class records have been defined, and the students have received an announcement of the class and they may enroll in step 416. Students who do enroll receive an enrollment confirmation notice generated by the system at step 418. At step 420, all registered students receive automatically generated reminder notices at user-defined intervals before the class.

While the class is open for enrollment, the size of the enrollment is monitored by the invention at step 422. In one embodiment of the invention, a waitlist will be generated if a class reaches its maximum enrollment. The registrar receives notice of any class that does not reach its minimum or maximum enrollment. In one embodiment of the invention, before a class is held the system automatically generates an instructor packet in step 424.

The class is held at step 426. Students attend the class and sign in. When the class is complete, students fill out class evaluations and receive their certificates of completion that were generated as part of the instructor packet in step 424. After the class completes, at step 428, the instructor sends the sign in sheet to the registrar. The registrar records attendance, records “no-shows” and “incompletes,” and enters information into the system to ensure the correct calculation of charge backs. The registrar also sends the course evaluations to the vendor. In one embodiment of the invention, at step 430, charge backs are uploaded to the accounting system once a month for billing purposes.

Course Definition

FIG. 4B provides a more detailed view of the course definition process, in accordance with an embodiment of the invention. The course manager first defines a record for global course 401. Global course record 401 contains information about the course manager, the course code, the course name, and the course family. Examples of course family, or general subject matter of a course in one embodiment of the invention include:

Advanced Internet Technologies

Business applications

Business practices

Computer Aided Design (CAD)

Communicating for Results

Employee Development

Executive management

Enterprise servers

Executive training

Finance courses

Function specific

Field sales

Computer languages

Management and leadership

New hire training

Networking

Object technology

Operating systems

Project management

Quality training

Self study courses

Software development

Self-paced products

Systems applications

Team effectiveness

Workstation applications

Work skills training

Course family designations are important in providing refined catalog searches for students and others using the system. The invention contemplates the use of other family designations. In one embodiment of the invention a family designation may be defined by the course manager and comprise a set of characteristics defined by the manager.

After global course record 401 is defined, the course manager may define local course record 403. Local course record 403 specifies the delivery type of the class, the minimum and maximum class enrollment, course fees and revenue information, pre-work required of the students, the course manager, if testing is required, the status of the class, notification information, and if the class should have an interest list. A description of local course 403 comprises an abstract, general description, audience, objectives, methods, prerequisites, materials, and other notes. Local course record 403 cannot be defined unless global course record 401 exists. Local course records may be used as templates for other local course records and then customized to meet regional training needs. For example, a course manager may copy a local course record and then change the language of the notification information to suit the employees of another country.

Next, a record for course location 405 is defined, if the location record does not already exist. Course location record 405 contains a location code, a geographic region code, a location name, description, status, address, contact, phone number and special instructions fields. A course location represents a place where classes may be held, for example a training center or an office building. Courses may be entered and/or located in multiple continents and provided in multiple languages. Depending on the embodiment of the invention, course location 405 may or may not represent an individual classroom. Therefore, it may also be possible to define a classroom record. For example, classroom record 407 can contain the following information: classroom name, location code, location name, status, description and capacity. Classes may be entered and/or located in multiple continents and provided in multiple languages.

Classes may be taught, or training products may be supplied by, suppliers. For example, a supplier can be any company that provides instructors and or educational materials. Suppliers can be internal or external to the corporation. For example, a department of the corporation may be a supplier. A commercial school that provides teachers is also a supplier, as is a company that sells instructional videotapes. Even classes defined for internal workgroups require supplier. Supplier record 409 should be defined before an instructor record can be defined, as it is used to track instructor billing and revenue. Supplier record 409 contains the following information: id, supplier company name, address, country, email, and phone. In addition, internal suppliers may have a URL field in supplier record 409.

After supplier record 409 is defined, an instructor can be assigned to the class. Instructor record 411 contains information as follows: instructor name, type, status, supplier record and rate. Instructors should be associated with a supplier for billing and revenue purposes.

After all the above-described records exist the class manager, registrar or course manager may define class record 413. To define class record 413 an authorized user enters information into the system as follows: global course number, local course number, and supplier. If the course delivery type is classroom, the course manager will select a location and a classroom. The course manager also specifies if the class is an internal workgroup class, in which enrollment is restricted to certain employees and therefore the invention requires a password to allow student registration. Any class that is not an internal workgroup class may be an open enrollment class.

Next, the course manager sets the class status, which for a newly created class may be set to “new.” During the life of a class, its status can be one of the following values: new, available, full, post-class, cancelled, or completed. Class status is changed to “available” when the course manager wishes to open enrollment. Class notices and other information can be customized at the time class record 413 is defined.

Student Registration

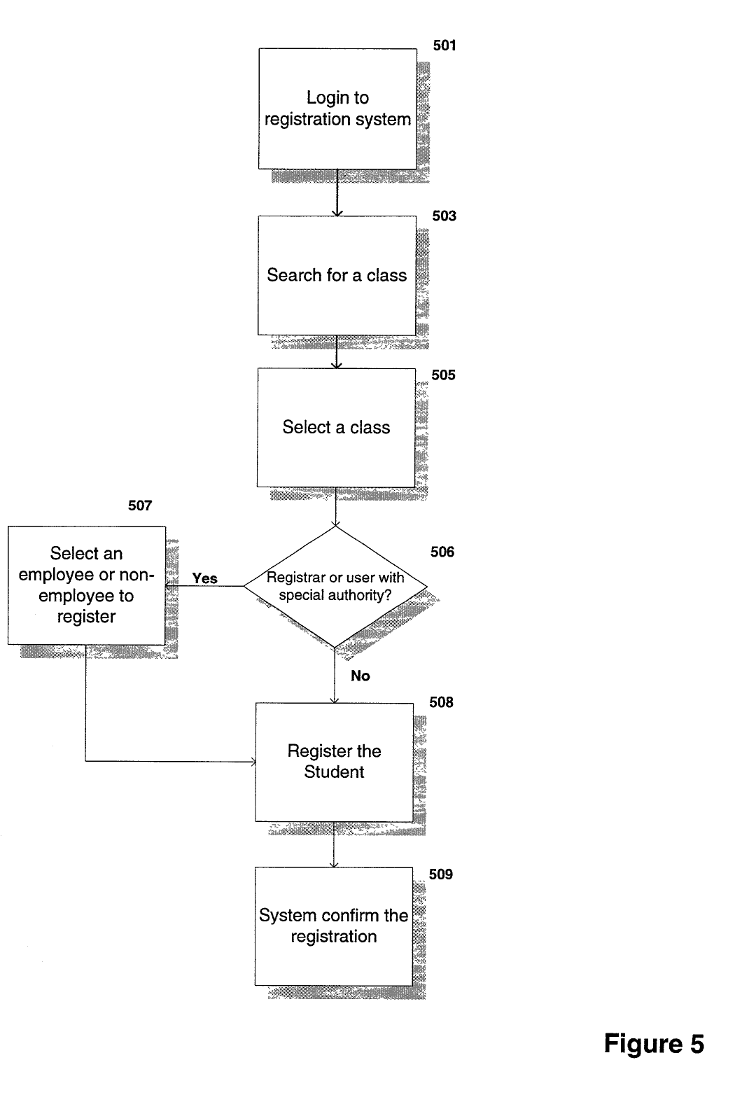

To register for a class using the method of an embodiment of the present invention, a student follows the steps detailed in FIG. 5. The first step, shown as step 501, requires the student to log into the registration system. In one embodiment of the invention, the log in function is performed by methods well known to those of ordinary skill in the art. For example, the method requires that the system verify the user's identity and authorization to perform a registration, by whatever method available. Registration may be performed from multiple continents and in multiple languages.

The method of one embodiment of the present invention does not require the prospective student to log into the system personally. In an enterprise environment, it is common for busy executives and others to have assistants perform functions such as registering the executive for a class. A manager may also direct an employee to register all the members of a group for a class. The ability of a user who is logged into the system to register one or more others for classes is a feature of one embodiment of the present invention that is an example of the flexibility provided by one embodiment of the present invention to support enterprise environment training needs.

At step 503, the user searches the database of the invention for available classes that meet the user's criteria. Criteria may include the class title, number, delivery type, geographic region, and/or period during which the class will be offered. When a class has been identified, the user selects the class at step 505. At step 506 it is determined whether the user is a registrar or a user with special authority. If the user is a registrar or a user with special authority, then flow goes to step 507. If the user is not a registrar or a user with special authority, then flow goes to step 508.

At step 507, the user will select one or more employees or non-employees to register. One embodiment of the present invention provides the flexibility of registering non-employees because of the nature of an enterprise business environment. In a company with thousands of employees, the entry of new hires into the employee database is often not immediate. Yet, managers often wish to send their new hires to classes for training as soon as possible. By allowing users to register non-employees for classes, one embodiment of the present invention provides flexibility to let managers register new hires for classes, without requiring the employee database to reflect all new hires on a daily basis. At step 508 the system registers the student. In the final step of the registration process, step 509, the system confirms the registration to the user.

Class Cancellation

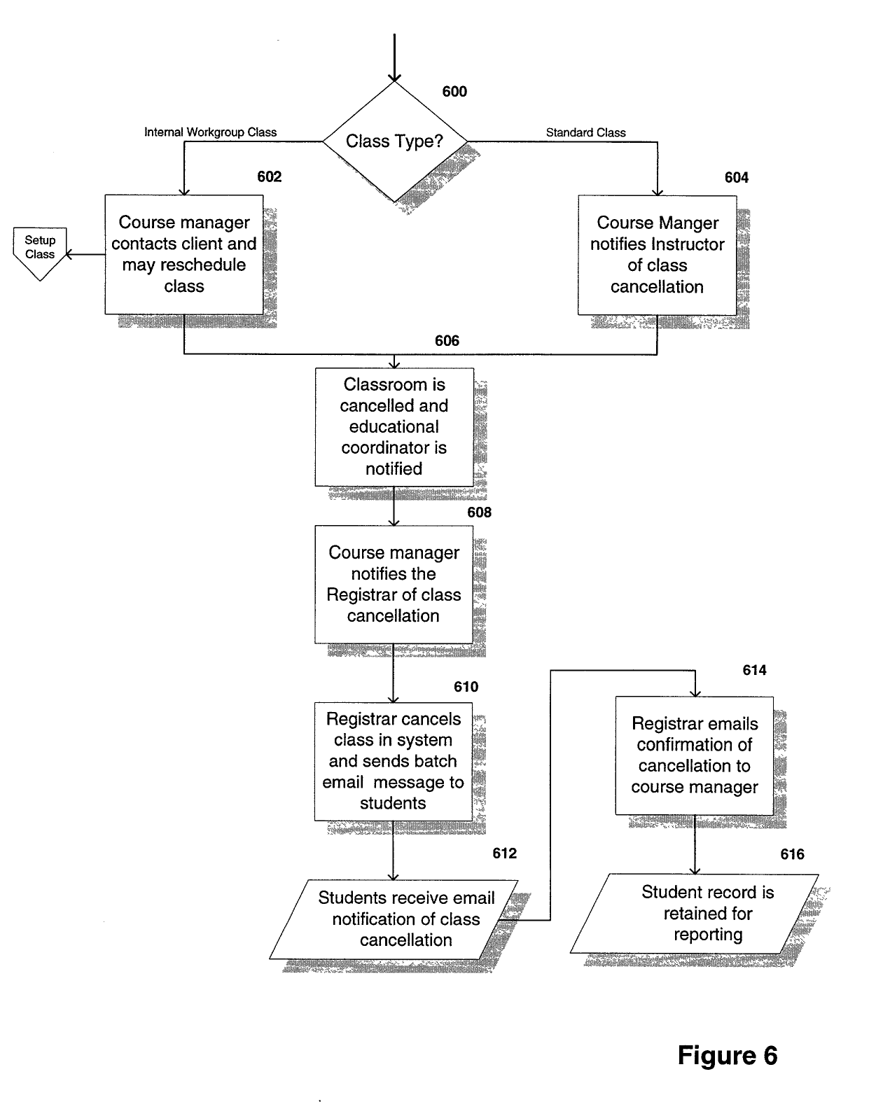

The method for canceling a class in one embodiment of the present invention is illustrated in FIG. 6. Step 600 asks what type of class is being cancelled. For internal workgroup classes, step 602, the course manager and client are notified. The client may wish to reschedule the class, using the class setup process described in FIG. 4B. If the class is a standard class then, at step 604, the course manager notifies the instructor of the cancellation. In either case at step 606 use of the classroom is cancelled and the educational coordinator, the employee responsible for the maintenance of the classroom, is notified of the cancellation. In one embodiment of the present invention, the course manager is responsible for notifying the registrar of the cancellation, which occurs at step 608.

The registrar enters the cancellation into the computer system at step 610. The system sends batch email notification to the students registered for the class indicating that the class has been cancelled. Students receive this notice at step 612. The registrar, at step 614, then emails confirmation of the cancellation back to the course manager. Step 616 shows that student records are retained for reporting purposes.

Pre and Post Class Tracking and Processing

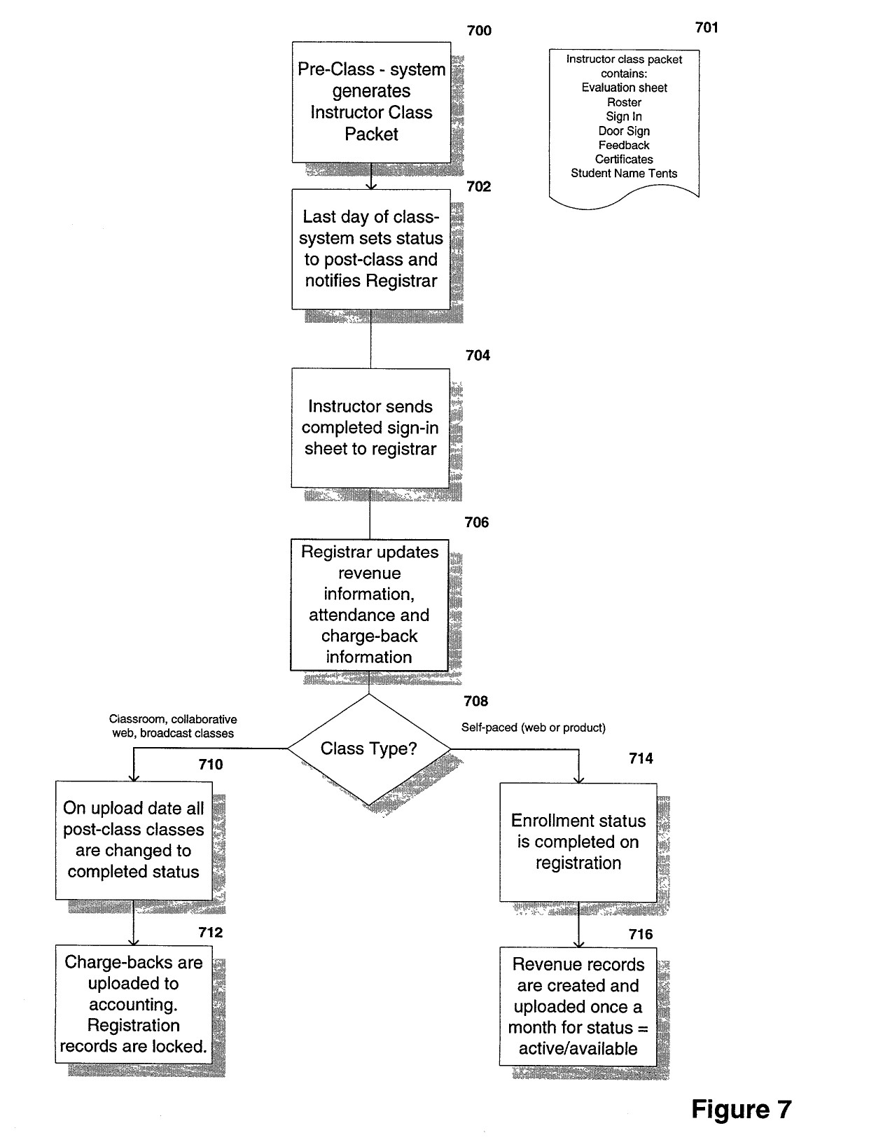

One embodiment of the present invention provides support for an enterprise employee-training environment by performing a number of automated tracking processes and other pre-class and post-class processes. These processes are detailed in FIG. 7. Pre-class processing is described at step 700, where the system automatically generates instructor class packet 701. Instructor class packet 701 is made by batch process some days before the class. To support a global training environment instructor class packet 701 is posted on a web site, so instructors anywhere in the world can easily download their packets. Instructor class packet 701 may contain, for example: an evaluation sheet, a roster listing all students registered for the class, a sign-in sheet, a door sign, feedback forms, certificates of completion, and student name tents for each student registered in the class.

The system also tracks student registration and participation in classes. For example, on the final day of a class, at step 702, the system automatically sets the class status to “post-class”, and notifies the registrar. The instructor sends the completed sign-in sheet to the registrar at step 704. At step 706, the registrar is responsible for updating the attendance, revenue, and charge-back information in the class records.

At step 708 it is determined what the class type is. If the class type is a self-paced, then the system sets the enrollment status to “complete” as soon as the student registers, at step 714. At step 716 the system automatically updates revenue records for self-paced classes and ensures upload of the records to the corporate accounting system.

For all other class types (e.g. classroom, collaborative web, broadcast classes), at step 710, on a designated day of the month all classes with status of “post-class” are accounted for, and the class status is automatically changed to “complete” by the system. At step 712 the charge backs entered by the registrar are uploaded to the corporate accounting system, and the registration records are then locked to prevent further changes. Tracking another pre-class and post-class processing may be performed from multiple continents and in multiple languages.

Product Accounting System Interface

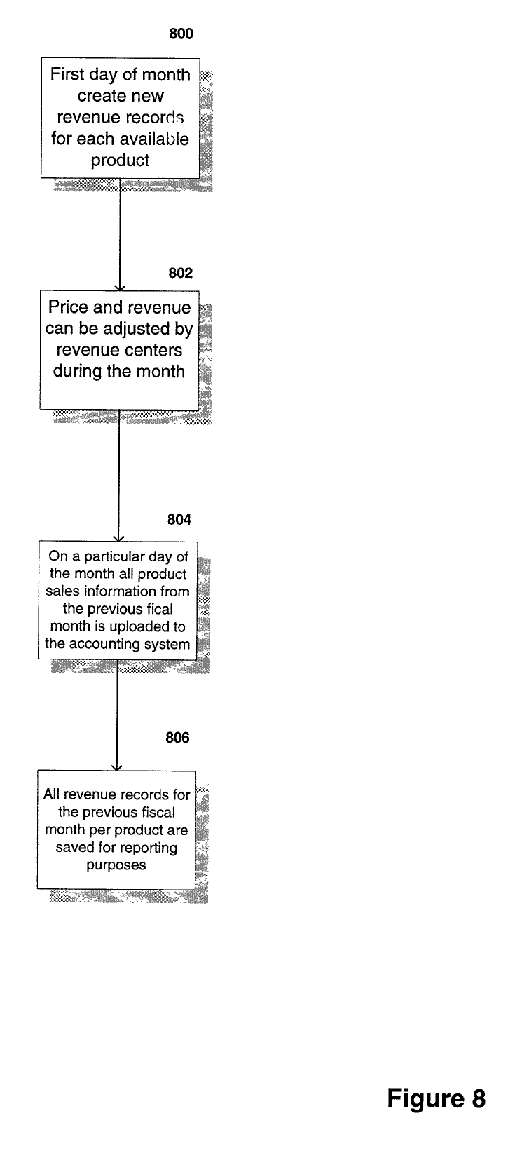

FIG. 8 demonstrates the processes of the invention for managing accounting of employee training products, such as books, videos, and self-paced web classes according to one embodiment of the present invention. For example, the product accounting system can be used to manage other class accounting needs such as providing a student with a class refund, or charging a department of other types of services rendered.

At step 800, on the first day of the fiscal month, new revenue records are defined for each available training product. During the month, at step 802, local revenue centers may adjust the price and revenue figures for any product in the catalog. At step 804, on a particular day of the fiscal month so designated, the invention automatically uploads all revenue records for the previous fiscal month to the corporate accounting system. At step 806, the system saves all the monthly revenue records for reporting purposes.

System Reporting

Frequent monitoring by management can be used to tailor an employee training system to meet the needs of an enterprise corporation. Monitoring and reporting may be performed from multiple continents and in multiple languages. One embodiment of the invention produces the following reports:

Daily Class Cancellations

Daily classes filled

Daily class confirmation summary

Daily class reminder summary

Daily enrollment deadline report

Daily merged student record report

Course schedule by course number/class contact

Room schedule by date

Monthly revenue detail by revenue account

Monthly revenue account (summary)

### Software Programs and Administrator Tools

One embodiment of the present invention is implemented in Java, and makes use of Sun Microsystems' JavaWebServer™ product. It will be apparent, however, to one skilled in the art, that one embodiment of the present invention may be practiced without this specific detail. In other instances, well-known features have not been described in detail so as not to obscure the invention.

In the following description, a distinction is made between an HTML page and an HTML form. For the purposes of this specification, an HTML form may be a page that requests the user to input data into fields on the page, or request information from the server. An HTML page may be a display-only page that may contain links to other pages or forms, but may not contain input fields or request elements.

A. Web Server Framework Extensions

Managing a Global Training Environment

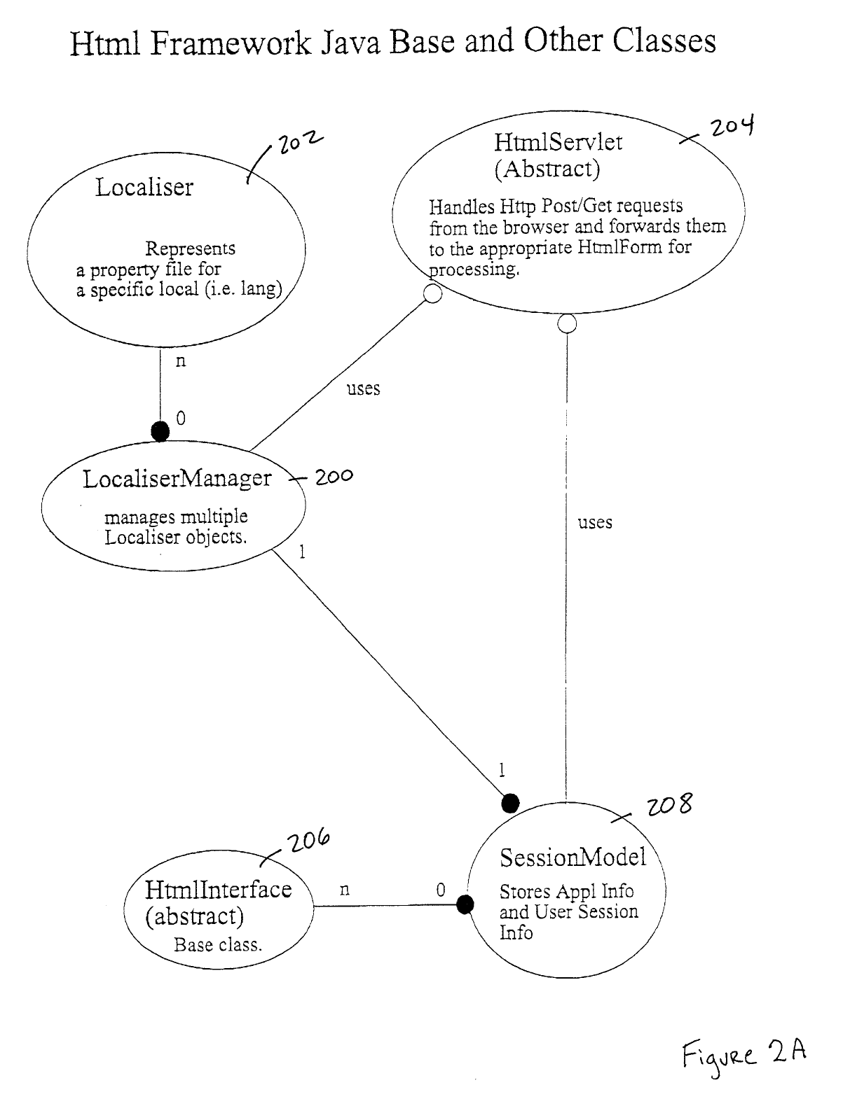

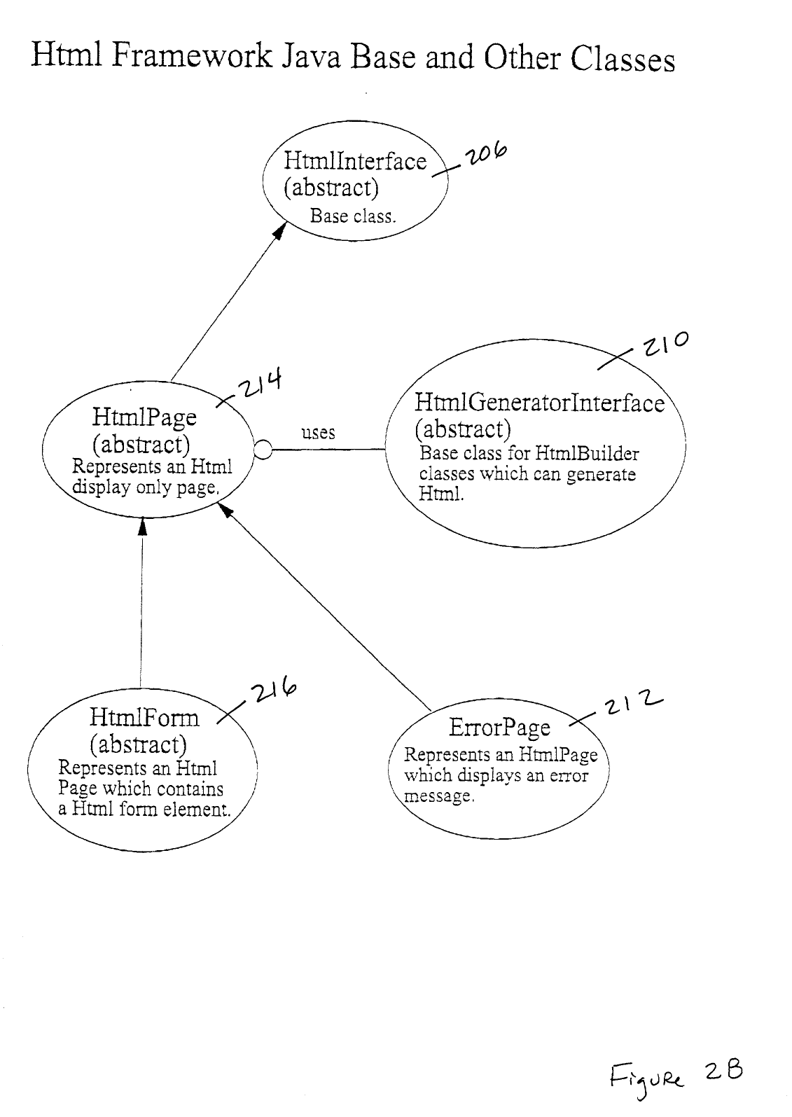

In an enterprise environment, user interface web pages may be displayed in the languages spoken at different company sites around the world. Web browser applications, such as Netscape Navigator or Microsoft Internet Explorer, provide users the option to select which language they want a web page displayed in if the web page developer has provided the page in multiple languages. FIGS. 2A and 2B illustrate the relationship between the objects used to implement one embodiment of the present invention. In one embodiment of the present invention, LocalizerManager 200 component allows an interface programmer to easily deal with multilingual labels, components, exceptions and objects by storing those items as strings in property files. The LocalizerManager reads the strings and selects the correct versions to appear on the interface display, based on the user's language choice as specified by the web browser making the request for the web page.

A LocalizerManager instance comprises Localizer objects 202 for a specific locale for the application. There is one Localizer object for each page (and/or form) in the local application. Each page is stored in its own property file. If we supported two languages for an application (for example, English and French), and the application contained 10 web pages, then there would be 20 property files: 10 in English and 10 in French. The browser language choice setting is determined by HTMLServlet object 204, which reads, an HTML header sent by the browser.

The LocalizerManager class also contains static methods and static private members. It has a static hash table of LocalizerManager instances that contain the LocalizerManager objects for each locale. The static methods are called by the interface application to retrieve the correct LocalizerManager instance for a specific locale. Making the LocalizerManager instances static improves their performance, since property files need only to be read once for all instances of the application.

The WWW Server

One embodiment of the invention uses the JavaWebServer™ as WWW Server component (e.g. block 102 of FIG. 1). JavaWebServer™ supports the use of Java “servlets.” A servlets can almost be thought of as and applet that runs on the server side—without a face. JavaWebServer™ provides a Java class called HTTPServlet that can process HTTP Form Post and Get request from a browser. An application sub-classes HTTPServlet to implement the functionality to actually process the request. Then the application defines a servlet to JavaWebServer™ that points to this HTTPServlet sub-class. The user interface application, via the browser, contacts this servlet by specifying a URL that identifies this application servlet. The JavaWebServer™ product has the ability to assign a “session area” to a user (browser) when it contacts the JavaWebServer™ servlet to start a session. It is possible to store application information (including Java objects) in this session storage area.

User Authentication

One embodiment of the invention requires users to log into the system before registering for classes or administering the system. The LoginServer component builds on the feature of the web server to provide user session data storage. A user interface application using the LoginServer will sub-class a Java class called AuthHTTPServlet (which is part of the LoginServer package) instead of HTTPServlet. AuthHTTPServlet is a sub-class of HTTPServlet. However, one embodiment of the present invention's functionality is not dependent on the LoginServer. The invention may be practiced without this feature by implementing the system to use other authentication methods, or the invention could be implemented to use the JavaWebServer™ sessions directly.

On receipt of a browser HTTP Post or Get request, the application servlet (a subclass of the AuthHTTPServlet) checks to see if this user has an existing JavaWebServer™ session. If not, the AuthHTTPServlet will redirect the user to the login screen. Once the user has logged in successfully, the AuthHTTPServlet will assign this user a session in the JavaWebServer™. If the user later sends HTTP Post or Get requests from the application servlet, the LoginServer can recognize that the request belongs to an existing session, and retrieves stored information from the JavaWebServer™ session for this user. However, the LoginServer itself only stores user information such as the user's name, not the session data.

The HTMLFramework

The HTMLFramework is an extension of the JavaWebServer™. Session data may dictate what type of data to store in SessionModel 208, how to manage it, how to define navigation from one page to the next, how to go back to a previous page, and to how display an error message with the user's erroneous input displayed. The HTMLFramework, according to an embodiment, is illustrated in FIG. 2A and 2B, and described below.

Session data is stored in an instance of a class called SessionModel, which is instantiated when a user session begins. The SessionModel object is used to store all application specific information for this user's application session.

The HTMLServlet initializes the user's SessionModel after the user has been authenticated by the LoginServer component. When the session's first request is passed to the HTMLServlet it will create a new SessionModel instance and populate it with any required system data, such as the JavaWebServer's™ host system fully qualified name. The HTMLServlet will also retrieve the appropriate LocalizerManager for this user's locale, and store this information in the SessionModel.

In one embodiment of the invention, the HTMLFramework's HTMLServlet Java class sub-classes HTTPAuthServlet (from the LoginServer component) to take advantage of its support for user authentication.

The HTMLServlet sub-class for an application is responsible for:

initializing an user's application session;

sending all HTML generated by HTMLPages and HTMLForms to the browser;

displaying and routing requests to the correct HTMLForm for processing; and

processing all HTTP Post and/or Get requests from the form elements on the application's HTML pages;

HTMLInterface class 206 is a Java interface which represents an object that can send HTML to a browser. It acts as a base class for the HTMLPage and HTMLForm classes.

The HTMLPage class 214 represents a page containing HTML, but does not contain a form element. HTMLPage class implements HTMLInterface 206. It uses an HTMLGeneratorInterface object to generate this HTML. There can be many implementations of HTMLGeneratorInterface 210. The default implementation in one embodiment of the present invention is called the HTMLBuilder. The HTMLPage sub-class can define which HTMLGeneratorInterface implementation can be used to generate the HTML for this page. The HTMLPage can be sub-classed by a user interface application to implement the specifics of what the page should display.

The HTMLForm class 216 represents a page containing HTML form elements. (An HTML form allows the user to enter data and/or make a request of the server for a particular action). An HTMLForm class knows how to process the data entered on the HTML page by the user and will return it's response in the form of the next HTMLPage or HTMLForm. An HTMLForm inherits all functionality of it's parent class HTMLPage (so it knows how to generate HTML to the browser) as well as process data from the form on this page. The HTMLForm can be sub-classed by an application to implement the specifics of what this page should display and where its form data should be sent.

ErrorPage 212 is simply a special kind of HTMLPage that displays an error message. It is not abstract and can be instantiated.

In one embodiment of the present invention, the HTMLFramework should have a one-to-one relationship between every HTML application page displayed on the browser and a Java class that supports it on the server (either an HTMLPage sub-class, HTMLForm sub-class, or the ErrorPage).

Dynamic HTML Generation

Each HTMLPage and HTMLForm sub-class is able to generate the HTML for its application display. Each HTMLForm sub-class knows how to process the data from its HTML form and perform the requested function (i.e. retrieving data from the database, saving data to the database, performing calculations, etc.) Each HTMLForm also knows the next HTMLForm or HTMLPage sub-class that should be displayed. In this way, the application controls user navigation. The next HTMLPage or HTMLForm to display might display the results of a database query or a calculation or simply collect additional information required. Each HTMLForm sub-class can also store data entered by the user on its form and display the data returned from a database query or calculation.

If an error occurs during the processing of user input data, an HTMLForm can decide that the next HTMLPage or HTMLForm should not be displayed—instead the HTMLForm will displayed an appropriate error message and display the entry form populated with the data the user entered.

Likewise, an HTMLPage sub-class can be designed to display data given to it. It can be given data during its construction, or before it is asked to generate its HTML. The HTMLPage can display this data by incorporating the data into the HTML it generates.

Alternatively, the navigation can be circular with the HTMLForm always redisplaying itself with the data the user entered, the results of the database retrieval or calculation. This gives the user the opportunity to enter another request.

Since an HTMLForm element can have many different buttons that define many different actions, an HTMLForm may actually navigate to many different HTMLPages or HTMLForms, one for each action defined on the HTMLForm element.

An HTMLForm sub-class can be implemented to give a newly created instance of itself a unique name that can identify this instance. Each HTMLForm uses the JavaWebServer™ application servlet URL for the application's HTMLServlet sub-class when specifying an action for its form element. By default, the HTMLForm will add hidden fields to its form element. These hidden fields are used by the HTMLServlet to identify which HTMLForm should process a request from a browser. In particular, it adds two hidden fields that contain the following information:

the Java class name of the HTMLForm sub-class that generated the HTML for this page; and

the unique name for this instance of that HTMLForm sub-class.

When the HTMLForm generates the HTML for its page, it will add these hidden fields to its form element. After the user enters data and presses a button on the form, the HTMLForm sends an HTTP Post or Get request to the application's HTMLServlet with all the data entered by the user in addition to the data in any hidden fields.

When an HTMLPage generates HTML, it actually is sent to the HTMLServlet who sends it back to the user's browser. If the HTML was generated from an HTMLForm, the HTMLServlet will save the instance of the HTMLForm that generated that page in SessionModel. This is so it can be retrieved to process any HTTP Post/Get request generated from the form element in the HTML that was just sent to the user by this HTMLForm.

When the HTMLServlet gets the HTTP Post and/or Get request, it locates the hidden fields containing the HTMLForm sub-class Java class name and the unique name for this instance of that HTMLForm sub-class. The HTMLServlet then attempts to retrieve the HTMLForm instance from the SessionModel that has the specified unique name. If the HTMLForm cannot find that unique instance it will instantiate a new instance of the proper HTMLForm sub-class, using the sub-class name.

In some cases, an HTMLForm instance may not be in the SessionModel. The user can navigate to a previous page using the browser's back/forward buttons, or other navigation elements on the application HTML page. Therefore, even when an HTMLForm is displayed the user may not enter data on that page at that time. One embodiment of the present invention therefore supports a model where the user may change his mind about what he is doing on any page and go to some other functional area in the application. The user could then come back to this HTMLForm page later.

Managing User State Data

Providing HTML user interface applications with user state information may tax system resources. HTML is an essentially stateless formatting language. In providing the user interface application with state information as described above, the SessionModel object may become full of HTMLForm instances that have been previously displayed. The HTMLFramework allows the application to be configured to specify the maximum number of HTMLForms that can be stored in the SessionModel. After this maximum is reached, the oldest HTMLForms are discarded.

Once the HTMLServlet retrieves (or creates) the proper HTMLForm, it passes the HTTP Post and/or Get request data to this HTMLForm sub-class for processing. The HTMLForm sub-class will retrieve the data entered by the user or perform the action specified by the user (as defined by which button was pressed on the HTML page). The HTMLServlet will then perform the specified function.

According to an embodiment, the HTMLServlet first decides which HTMLForm or HTMLPage sub-class should be displayed next. It then instantiates the appropriate page, populates the page with data retrieved from the database or generated from some calculation, and returns this new HTMLForm or HTMLPage to the HTMLServlet. In the case of an error, the HTMLForm that processed the HTTP Post or Get request might return itself to the HTMLServlet.

The HTMLServlet then asks the HTMLForm or HTMLPage sub-class it received from the HTMLForm to generate the HTML for its page and sends this page back to the browser. Additionally, the HTMLServlet sub-class for a specific application can get and store application-required system data in the SessionModel. For example, the user's name, email address, or application authority levels may be stored in the SessionModel.

When the HTMLServlet asks for an HTMLPage or HTMLForm to generate its HTML, or asks an HTMLForm to process an HTTP Get or Post request, the HTMLServlet will retrieve the SessionModel data for this session and pass that data to the HTMLPage or HTMLForm. This way the HTMLPage or HTMLForm can store or retrieve any data within the SessionModel it may need.

B. The HTML Builder Object

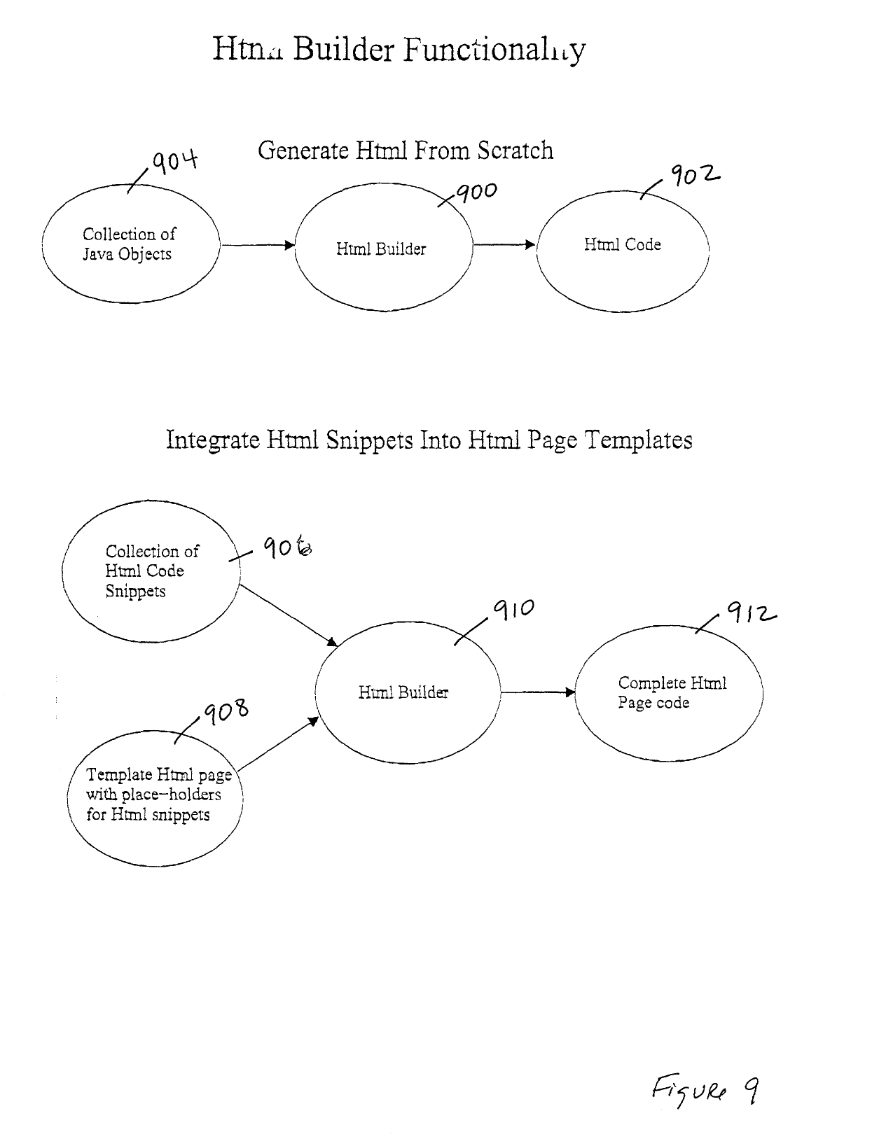

One embodiment of the present invention generates HTML pages on demand using an object called the HTMLBuilder. The HTMLBuilder is illustrated in FIG. 9. HTMLBuilder object 900 generates HTML code for the web browser based on information stored in data files called property files for HTML objects. The HTMLBuilder reads the property files, locates the special codes indicating the presence of a variable, and then processes the variables by inserting data values into the placeholders defined by the variables. The resultant HTML code 902 is sent to the browser for display.

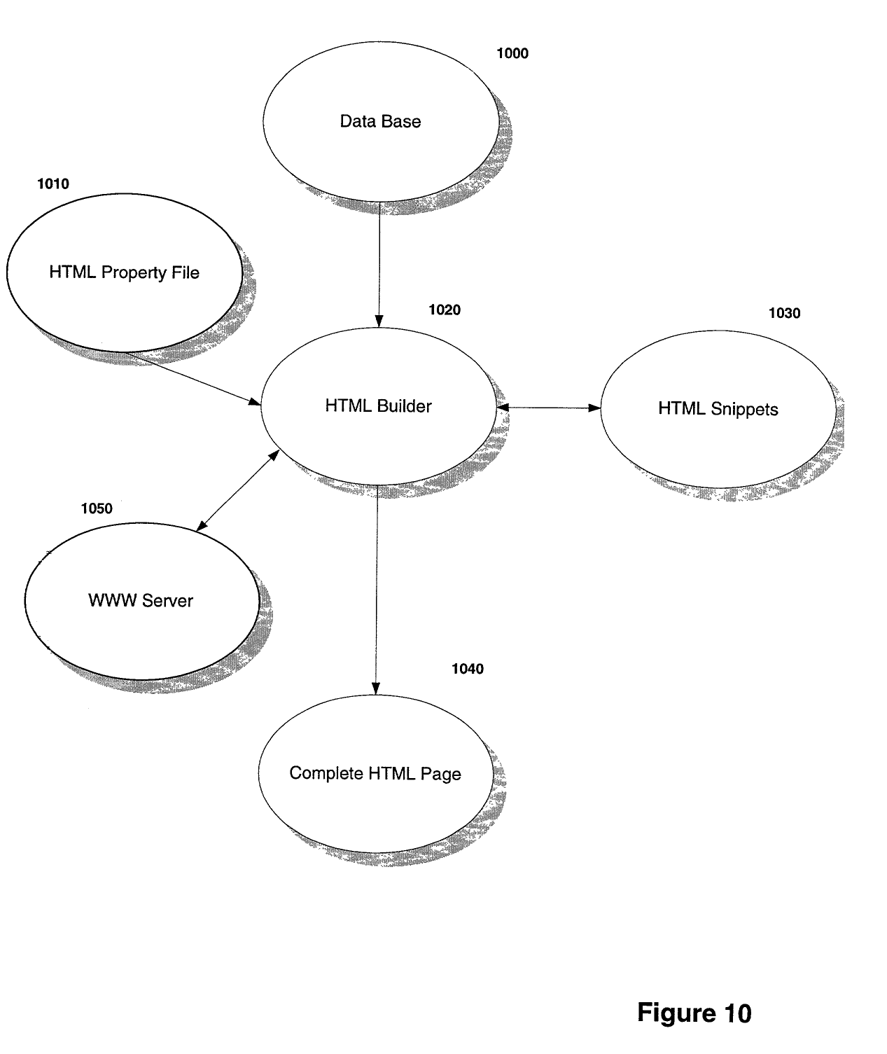

FIG. 10 details the data flow to and from HTMLBuilder object 1020 in one embodiment of the present invention. When the user interface application is loaded by the browser and the application makes its first request to WWW server 1050, HTMLBuilder object 1020 is invoked to generate the appropriate HTML code. The HTML code for each page to be delivered by server 1050 to the user's browser is generated on demand, with data being retrieved from or sent to database server 1000 as needed. A more detailed explanation of the HTMLBuilder functionality is as follows.

The first step in generating an HTML page for the user interface application is for HTMLBuilder 1020 to retrieve HTML property file 1010 from server 1050. HTML property file 1010 may contain static HTML, database variables and macros, and HTMLBuilder 1020 variables.

When a browser sends a request to server 1050 the HTTPServlet receives the request. The HTTPServlet retrieves the appropriate data from the database for HTMLBuilder 1020. HTMLBuilder 1020 will then use the data to generate “HTML snippets” 1030. (HTML snippets 906 are HTML format commands elements that contain values that can only be determined at runtime.) HTMLBuilder object 1020 combines HTML property file 1010, database values specified in HTML property file 1010, and HTML snippets 1030 to generate completed HTML page 1040. Completed HTML page 1040 is then returned to the user's browser for display. Competed HTML page 1040 appears to the browser to be a standard static HTML page.

Using HTML property file 1010 and database values to generate HTML pages on demand allows one embodiment of the present invention to provide multilingual support for a global employee training system. If a user interface application for a new user language is required, system personnel need only generate a new property file in that language. After a new property file 1010 is placed on server 102, and the user selects a corresponding language using their web browser, the user interface will be displayed in the user's selected language. In one embodiment of the present invention, database 1000 is also designed to support multiple language character sets, allowing course descriptions and other information to be entered in any language. Thus, through the combination of the database design and HTMLBuilder object 1020 one embodiment of the present invention provides seamless support for a global enterprise employee training system.

C. Search Processing

One function of the present invention requires providing the user the ability to easily search various criteria of the database for registration, accounting, and maintenance purposes. One embodiment of the present invention provides two different user interfaces for searching the database. The first interface is provided to administrative users, and is a generic search capability. This interface is illustrated in FIG. 11. The second interface provided is for student registration, and is HTML-based. Both interfaces use the same underlying search server.

The approach for searching a large database with flexible criteria is as follows. The client process, either the administrator or student, sends a vector of search criteria objects to the search server. Each search criteria object contains a Business Object class name and method name that defines the field to search, a search qualifier selected by the user for this field, a value to use as a search criteria. The search criteria object also contains information defining which fields to return from the search by specifying the Business Object class name and method name. For example, a search may search for all courses with a course name containing the word “Management”. As a result, for each such course found by the search, the course name, course manager name and course price will be returned to the searcher.

According to an embodiment, the following is a list of currently defined search qualifiers:

1=Starts with

2=Ending with

3=Contains

4=Is exactly

5=Less than

6=Less than or equal to

7=Greater than

8=Greater than or equal to

9=Equal.

The search server uses search criteria information to build a valid SQL statement and to execute the statement. Next, the search server looks for duplicate fields. If present duplicate fields can be joined by an “or” connector and surrounded by parentheses. The search server then looks up the appropriate SQL phrase for each search criteria in a table. Next, the search server checks to see if any joins are required. If any of the table names retrieved from the lookup table do not specify the same database table name then a join is required. If joins are required, they are also handled by lookup, in another lookup table. All SQL phrases retrieved from either of the lookup tables are then concatenated with “and” connectors, unless they are for duplicate fields, in which case they are connected with “or” connectors.

D. Notification System

A central feature of an embodiment of the invention is a reliable, fault-tolerate automated notification system. A notification is an email sent to someone regarding an event occurring within the system of one embodiment of the present invention. There are several types of notification. For example, when a student registers for a class a confirmation notification is sent to the to the student, as well as to the student's manager. A reminder is sent 21 days before the class, and this is sent to the person who enrolled the student (if the student was not self-enrolled) and to the student's manager.

A notification can be “immediate” or “scheduled”. For immediate notification, the server will send the notice after processing the client request. A scheduled notification is sent by batch processing program on a specified date.

Default notification information, for both scheduled and immediate notices, may be stored in a table in the database. An example of this table contains:

Notification type

The reference data type (e.g. class start date)

The number of days prior to the reference date when notification can be sent, for immediate notification this field is zero.

Generation type

Notification recipients (students, instructors, managers)

Default email text

Language of the default email text (e.g. English, French, etc.)

Notifications are copied from the course default notification to the class schedule notification table. All notifications may be modified by class. The Notification server uses the Email server to send the notifications.

For scheduled notification, a request can be made for the email server to send an email by writing the required data to the email server's queue, which is a table in the database. The batch program, which handles Scheduled notification, can also use the email server to send the emails. This ensures that all emails will be sent even if the batch program is interrupted or killed or if the server crashes. For each scheduled notification that the batch program is handling, it will use a single transaction to write the email requests to the email server's queue and to mark the scheduled notification as processed. By this method if any event in the database queue fails, all scheduled notices related to that event will also fails, ensuring that the notice system will reliably reflect the status of the database. This process is well known to those skilled in the art as double queuing. Using the database to queue email notification also automatically creates a record of the success or failure of the notification, which provides administrators the information they need to properly keep students informed of the status of classes in the system.

E. Batch Processing The following is a list of batch programs that may be used by one embodiment of the present invention. Batch processing optimizes interfaces to other systems in the corporation. Programs for batch processing can be written as scripts, programs or database stored procedures. The following functions of one embodiment of the present invention lend themselves to batch processing.

1. Class Waitlist Processing and Auto-Promotion

When an enrolled student cancels his registration, this process may promote the first student on the waitlist to a “promoted” status, and notify the student that space is available in the class. If the student does not register for the class within a specified time, the next student on the waitlist will be notified. Typical time allowed for a student to respond to a waitlist promotion notice is 24 hours. However, in a corporate environment many students will not work on Saturday and Sunday and therefore will not receive their promotion notice until after the time to reply has expired.

Lengthening the time to respond, however, may cause eligible students to miss a class that is schedule to begin in the near future. The problem is complicated in an enterprise environment because the corporation operates on a global scale, and students work in many different countries with varied work schedules. The solution in one embodiment of the invention is for the auto-promote batch program to recognize the day of the week. If it is run on Friday or Saturday, the program will only auto-promote the waitlisted students if the class starts within the next 48 hours. Response time is lengthened to 72 hours, solving the problem of requiring a response when students are not available to receive their waitlist promotion notice.

2. Notification

Nightly batch programs, which query the class notification table in the database, can send specified emails to enrolled students. If the student did not enroll himself then emails are sent to the person who enrolled the student, to that person's manager, and to the student. If the is student self-enrolled, only the student receives the email notification.

3. Post Class Processing

Updating student status to “completed” and class status to “post class” may be done automatically by the invention via batch processing after the class end date. This batch process calculates the class price for each student based on the class type and charge method. This date is later uploaded into the corporate accounting system.

4. Accounting System Upload

This batch process can calculate revenue from class registrations and product sales, and sends this data to the corporate accounting system on a regular basis. The dates this process executes should be determined relative to the fiscal needs of the corporate accounting system.

5. Company Employee Record Database Download

Nightly batch processes can download the refreshed employee database to the employee table of one embodiment of the present invention. In an enterprise environment, changes to the employee database on a day-to-day basis can be significant. Since new employee data can be entered into one embodiment of the present invention separately, to allow new hires to register for classes before their company records catch up with them, the changes to the company employee records can be reconciled with the employee records of one embodiment of the present invention on a nightly basis.

Embodiment of General Purpose Computer Environment

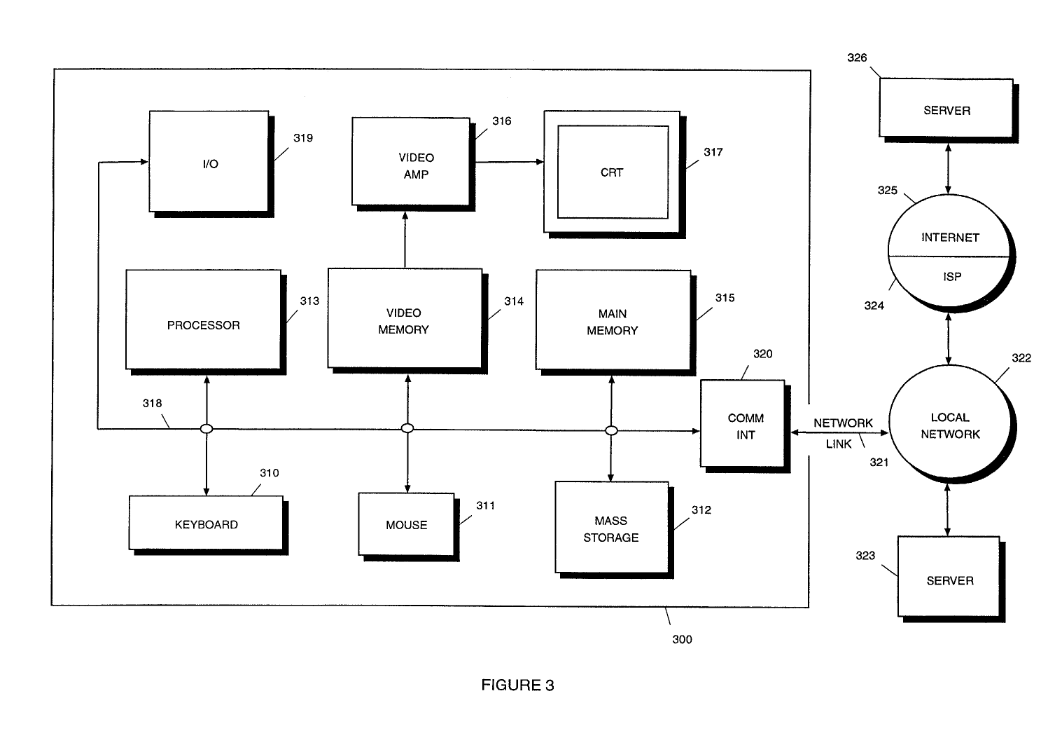

An embodiment of the invention can be implemented as computer software in the form of computer readable program code executed on one or more general-purpose computers such as computer 300 illustrated in FIG. 3. A keyboard 310 and mouse 311 are coupled to a bidirectional system bus 318 (e.g., PCI, ISA or other similar architecture). The keyboard and mouse are for introducing user input to the computer system and communicating that user input to central processing unit (CPU) 313. Other suitable input devices may be used in addition to, or in place of, the mouse 311 and keyboard 310. I/O (input/output) unit 319 coupled to bidirectional system bus 318 represents possible output devices such as a printer or an A/V (audio/video) device.

Computer 300 includes video memory 314, main memory 315, mass storage 312, and communication interface 320. All these devices are coupled to a bi-directional system bus 318 along with keyboard 310, mouse 311 and CPU 313. Mass storage 312 may include both fixed and removable media, such as magnetic, optical or magnetic optical storage systems or any other available mass storage technology. The system bus 318 provides a means for addressing video memory 314 or main memory 315. The system bus 318 also provides a mechanism for the CPU to transferring data between and among the components, such as main memory 315, video memory 314, and mass storage 312.

In one embodiment of the invention, the CPU 313 is a microprocessor manufactured by Motorola, such as the 680X0 processor, an Intel Pentium III processor, or an UltraSparc processor from Sun Microsystems. However, any other suitable processor or computer may be utilized. Video memory 314 is a dual-ported video random access memory. One port of the video memory 314 is coupled to video accelerator 316. The video accelerator device 316 is used to drive a CRT (cathode ray tube), and LCD (Liquid Crystal Display), or TFT (Thin-Film Transistor) monitor 317. The video accelerator 316 is well known in the art and may be implemented by any suitable apparatus. This circuitry converts pixel data stored in video memory 314 to a signal suitable for use by monitor 317. The monitor 317 is a type of monitor suitable for displaying graphic images.

Computer 300 may also include a communication interface 320 coupled to system bus 318. Communication interface 320 provides a two-way data communication coupling via a network link 321 to a network 322. For example, if communication interface 320 is a modem, communication interface 320 provides a data communication connection to a corresponding type of telephone line, which comprises part of a network link 321. If communication interface 320 is a Network Interface Card (NIC), communication interface 320 provides a data communication connection via network link 321 to a compatible network. Physical network links can include Ethernet, wireless, fiber optic, and cable television type links. In any such implementation, communication interface 320 sends and receives electrical, electromagnetic or optical signals that carry digital data streams representing various types of information.

Network link 321 typically provides data communication through one or more networks to other data devices. For example, network link 321 may provide a connection through local network 322 to a host computer 323 or to data equipment operated by an Internet Service Provider (ISP) 324. ISP 324 in turn provides data communication services through the worldwide packet data communication network now commonly referred to as the “Internet” 325. Local network 322 and Internet 325 both use electrical, electromagnetic or optical signals that carry digital data streams to files. The signals through the various networks and the signals on network link 321 and through communication interface 320, which carry the digital data to and from computer 300, are exemplary forms of carrier waves for transporting the digital information.

Computer 300 can send messages and receive data, including program code, through the network(s), network link 321, and communication interface 320. In the Internet example, server 326 might transmit a requested code for an application program through Internet 325, ISP 324, local network 322 and communication interface 320.

The computer systems described above are for purposes of example only. An embodiment of the invention may be implemented in any type of computer system or programming or processing environment.

Thus, a method and apparatus for managing an enterprise employee training system has been described. Particular embodiments described herein are illustrative only and should not limit the present invention thereby. The claims and their full scope of equivalents define the invention.

1. A method for managing an enterprise employee training system comprising:
defining a global course in a computer system having a memory medium;
assigning costs associated with said global course to at least one department of an entity;
defining a local course associated with said global course;
defining a class associated with said local source;
providing a localized interface for registering for said class.

2. The method of claim 1 wherein said localized interface comprises:
determining whether said interface comprises a snippet;
obtaining data associated with said snippet;
generating said localized interface using said data.

3. The method of claim 2 wherein said data is in a user specified language.

4. A method for providing an enterprise employee training system comprising:
defining at least one global course in a computer system having a memory medium, wherein said computer system further comprises data in a plurality of languages and localized interfaces accessible from a plurality of continents;
identifying a plurality of class presentation languages associated with said global course;
identifying a plurality of class location continents associated with said global course;
defining at least one class associated with said global course;
registering at least one student for said class;
presenting said class to said students;
tracking data related to said students' participation in said class.

5. The method of claim 4, further comprising:
defining a plurality of local courses associated with said global course and said at least one class, wherein said local course further comprises a course title, course description, and course prerequisites;
identifying a plurality of class presentation languages associated with said local courses;
identifying a plurality of class location continents associated with said local courses;
identifying at least one class delivery method associated with said local courses;
identifying a plurality of date formats and a plurality of calendar types associated with said local course for processing data related to a plurality of time zones;
assigning a plurality of costs associated with said local course to at least one department of an entity, wherein said costs further comprise costs in a plurality of currencies.

6. The method of claim 4, wherein said computer system further comprises a plurality of date formats, a plurality of calendar types, and data for a plurality of time zones.

7. The method of claim 4, further comprising identifying a plurality of date formats, a plurality of calendar types, and data related to a plurality of time zones associated with said global course.

8. The method of claim 4, wherein said global course further comprises a course title, course description, and course prerequisites.

9. The method of claim 4, further comprising assigning a plurality of costs associated with said global course to at least one department of an entity, wherein said costs further comprise costs in a plurality of currencies.

10. The method of claim 4, further comprising assigning at least one costs associated with said class to at least one department of an entity, wherein said costs further comprise costs in a plurality of currencies.

11. The method of claim 4, wherein said class comprises a class description, class number, at least one class location, at least one class presentation language, and at least one class schedule.

12. The method of claim 11, wherein said class schedule comprises information related to class presentation dates, class presentation times, and at least one class presentation language.

13. The method of claim 11, wherein said class schedule further comprises information related to data in a plurality of date formats, a plurality of calendar types, and data related to a plurality of time zones.

14. The method of claim 4, further comprising defining at least one class delivery method associated with said class.

15. The method of claim 14, wherein said class delivery method is by instructor, by video, by audio, by broadcast, by computer network, by Internet website, by books, or by self paced.

16. The method of claim 4, wherein said class comprises class education materials in a plurality of class presentation languages.

17. The method of claim 16, further comprising notifying class suppliers of class education material requirements for developing said class education material.

18. The method of claim 17, wherein said class education material requirements further comprises a class description, class number, at least one class location, at least one class presentation language, at least one class schedule, and at least one class delivery method.

19. The method of claim 16, further comprising class suppliers developing said class education material in a plurality of class presentation languages.

20. The method of claim 4, further comprising a plurality of instructors for presenting class education material in a plurality of class presentation languages and in a plurality of class location continents.

21. The method of claim 20, further comprising notifying class suppliers of class education material instructor requirements for providing said class education material instructors.

22. The method of claim 20, further comprising notifying class education material instructors of class education material instructor requirements for presenting said class education material.

23. The method of claim 20, wherein said class education material instructor requirements further comprises a class description, class number, at least one class location, at least one class presentation language, at least one class schedule, and at least one class delivery method.

24. The method of claim 4, further comprising notifying at least one prospective student of said class and said class schedule.

25. The method of claim 24, wherein said notifying of said class and said class schedule comprises notification in a plurality of languages and notification at localized interfaces located in a plurality of continents.

26. The method of claim 24, wherein said notifying of said class and said class schedule further comprises a plurality of date formats, a plurality of calendar types, and data related to a plurality of time zones.

27. The method of claim 24, wherein said notifying of said class and said class schedule comprises at least one notification e-mail.

28. The method of claim 24, wherein said notifying of said class and said class schedule further comprises notification of said class delivery methods and class presentation language.

29. The method of claim 4, wherein said registering at least one student for said class further comprises registering in a plurality of languages and registering at localized interfaces located in a plurality of continents.

30. The method of claim 29, wherein said registering further comprises a plurality of date formats, a plurality of calendar types, and data related to a plurality of time zones.

31. The method of claim 8, wherein said registering comprises registration criteria associated with said course prerequisites.

32. The method of claim 4, wherein said presenting said at least one class to said students further comprises presenting in a plurality of class presentation languages and presenting in a plurality of class location continents.

33. The method of claim 32, wherein said presenting comprises at least one notifying class education material instructor presenting class education material in a plurality of class presentation languages and presenting in a plurality of class location continents.

34. The method of claim 32, wherein said presenting comprises presenting class education material according to a class delivery method associated with said class.

35. The method of claim 4, wherein said tracking data related to said students participation in said class further comprises tracking data associated with students registered for said class.

36. The method of claim 35, wherein said tracking further comprises tracking data related to an inventory of said class education material.

37. The method of claim 4, wherein said tracking further comprises recording data associated with attendance of said students in said of classes, said plurality of class presentation languages, and said plurality of class location continents.

38. The method of claim 37, wherein said tracking further comprises a plurality of date formats, a plurality of calendar types, and data related to a plurality of time zones.

39. The method of claim 35, wherein said tracking comprises recording data associated with student registration, student attendance, and student completion for said classes.

40. The method of claim 35, wherein said tracking comprises recording data associated with billing and payment for said student's participation in classes.

41. The method of claim 4, further comprising calculating a history of completed classes for said students.

42. The method of claim 4, further comprising billing an entity for completed classes.

43. The method of claim 42, wherein said billing further comprises billing in a plurality of currencies, billing in a plurality of languages, and billing at localized interfaces located in a plurality of continents.

44. The method of claim 4, further comprising reporting data associated with said training system.

45. The method of claim 44, wherein said reporting data comprises data associated with said classes presented in a plurality of class presentation languages and presented in a plurality of class location continents.

46. The method of claim 44, wherein said reporting further comprises reporting in a plurality of languages and at localized interfaces located in a plurality of continents.

47. The method of claim 46, wherein said reporting further comprises a plurality of date formats, a plurality of calendar types, and data related to a plurality of time zones.

48. The method of claim 44, wherein said reporting further comprises reporting accounting data related to billing to an entity.

49. The method of claim 4, further comprising providing secure access to said computer system.

50. The method of claim 49, wherein said providing secure access further comprises providing secure access in a plurality of languages and at localized interfaces located in a plurality of continents.

51. The method of claim 50, wherein said providing secure access further comprises access permission levels for accessing training system data.

52. The method of claim 4, further comprising managing said training system according to training rules.

53. The method of claim 52, wherein said training rules comprise rules related data in a plurality of languages, associated with localized interfaces located in a plurality of continents, in a plurality of date formats, a plurality of calendar types, and data related to a plurality of time zones.

54. The method of claim 4, further comprising managing said computer system according to computer system rules.

55. The method of claim 54, wherein said computer system rules are configured to manage a computer system having data in a plurality of languages, associated with localized interfaces located in a plurality of continents, in a plurality of date formats, in a plurality of calendar types, and related to a plurality of time zones.

56. The method of claim 4, further comprising periodically performing said tracking, billing, reporting, and managing.

57. The method of claim 4, further comprising performing batch processing of said data associated with said courses, classes, registering, presenting, and tracking.

58. The method of claim 4, further comprising:
determining whether said localized interfaces located in a plurality of continents comprises a snippet
obtaining data associated with said snippet;
generating said localized interfaces using said data.

59. The method of claim 58, wherein said snippet comprises an HTML format commands elements that comprise values determined at runtime.

60. The method of claim 59, wherein said data is in a user specified language.

61. A method for providing an enterprise employee training system comprising:
defining at least one global course in a computer system having a memory medium, wherein said computer system further comprises data in a plurality of languages and localized interfaces located in a plurality of continents;
identifying a plurality of class presentation languages associated with said global course;
identifying a plurality of class location continents associated with said global course;
identifying a plurality of date formats, a plurality of calendar types, and data related to a plurality of time zones associated with said global course;
defining at least one class associated with said global course, wherein said class comprises at least one class location, at least one class presentation language, class education materials in a plurality of class presentation languages, at least one class delivery method, and at least one class schedule; wherein said class schedule comprises information related to data in a plurality of date formats, a plurality of calendar types, and data related to a plurality of time zones;
notifying at least one prospective student of said class and said class schedule, wherein said notifying comprises notification in a plurality of languages and notification at localized interfaces located in a plurality of continents;
registering at least one student for said class, wherein said registering comprises registering in a plurality of languages, registering at localized interfaces located in a plurality of continents, a plurality of date formats, a plurality of calendar types, and data related to a plurality of time zones;
presenting said class to said students;
tracking data related to said students participation in said class, wherein said tracking comprises recording data associated with student registration for said classes, a plurality of date formats, a plurality of calendar types, and data related to a plurality of time zones;
billing an entity for completed classes, wherein said billing comprises billing in a plurality of currencies, in a plurality of languages, and at localized interfaces located in a plurality of continents;
reporting data associated with said training system, wherein said reporting comprises reporting in a plurality of languages and at localized interfaces located in a plurality of continents, a plurality of date formats, a plurality of calendar types, and data related to a plurality of time zones;
providing secure access to said computer system, wherein said secure access further comprises secure access in a plurality of languages and at localized interfaces located in a plurality of continents, and access permission levels for accessing training system data;
managing said training system according to training rules, wherein said training rules comprise rules related data in a plurality of languages, associated with localized interfaces located in a plurality of continents, in a plurality of date formats, a plurality of calendar types, and data related to a plurality of time zones.

62. An enterprise employee training system comprising:
at least one database server comprising:
at least one memory medium;
data in a plurality of languages;
at least one course component comprising at least one global course, wherein said global course comprises a plurality of class presentation languages and a plurality of class location continents;
at least one class component comprising a plurality of classes associated with said global course;
at least one class scheduling component comprising at least one class schedule associated with said class;
at least one class registration component comprising at least one student registration for a class;
at least one class instruction component comprising at least one class delivery method for presenting said class to said students;
at least one tracking component comprising at least one method of tracking data related to said student's participation in said class, and
at least one global interface server configured to couple a plurality of localized interfaces located in a plurality of continents to said database server.

63. The apparatus of claim 62, wherein said classes comprise information related to data in a plurality of date formats, a plurality of calendar types, and data related to a plurality of time zones.

64. The apparatus of claim 62, wherein said class schedules comprises information in a plurality of languages and at localized interfaces located in a plurality of continents.

65 The apparatus of claim 62, further comprising a perspective student notification component comprising at least one class notice of said class schedules to at least one perspective student.

66. The apparatus of claim 62, wherein said class notices comprises information in a plurality of languages and at localized interfaces located in a plurality of continents.

67. The apparatus of claim 62, further comprising at least one student class request component comprising student requests to register for said classes.

68. The apparatus of claim 62, further comprising an education materials component comprising at least one set of class education materials in a plurality of class presentation languages.

69. The apparatus of claim 62, further comprising a class delivery method component comprising at least one class delivery method.

70. The apparatus of claim 62, further comprising a class instruction provider component comprising at least one method of providing class instruction to said students.

71. The apparatus of claim 62, wherein said tracking data further comprises data associated with student registration for said classes, a plurality of date formats, a plurality of calendar types, and data related to a plurality of time zones.

72. The apparatus of claim 62, wherein said tracking data further comprises data associated with a cost for said class.

73. The apparatus of claim 62, further comprising at least one billing server for billing an entity according to data related to said tracking data.

74. The apparatus of claim 62, further comprising a reporting component comprising at least one method of reporting information associate with said tracking.

75. The apparatus of claim 74, wherein said reporting component further comprises data related to said classes registered for, class costs associated with said classes, and billing for said classes.

76. The apparatus of claim 62, further comprising a computer system rules component comprising computer system rules configured to manage a computer system having data in a plurality of languages, associated with localized interfaces located in a plurality of continents, in a plurality of date formats, in a plurality of calendar types, and related to a plurality of time zones.

77. The apparatus of claim 62, further comprising a training system rules component comprising training system rules related to a plurality of class presentation languages, a plurality of class location continents, data in a plurality of date formats, data in a plurality of calendar types, and data related to a plurality of time zones.

78. The apparatus of claim 77, wherein said training system rules further comprise rules related to aid courses, classes, registering, presenting, and tracking, and said course prerequisites, a plurality of class presentation languages, and a plurality of class location continents.

79. The apparatus of claim 62, further comprising a multi-language interface component coupled to at least one global interface server, wherein said multi-language interface is configured to provide said plurality of class presentation languages, data in a plurality of date formats, data in a plurality of calendar types, and data related to a plurality of time zones.

80. The apparatus of claim 62, wherein said global interface server is further configured to provide communications to a plurality of class location continents and data related to a plurality of time zones.

81. The apparatus of claim 62, wherein said global interface server is an Internet web server.

82. The apparatus of claim 62, wherein said global interface server is an intranet server.

83. The apparatus of claim 62, wherein said localized interfaces further comprise at least one client device and at least one localized interface user application configured to communicate with at least one user in a plurality of languages, in a plurality of date formats, in a plurality of calendar types, and in a plurality of time zones.

84. The apparatus of claim 83, wherein said users comprise training system administrators, class suppliers, class education material instruction providers, class education material instructors, prospective students, students, and entities.

85. The apparatus of claim 62, further comprising at least one batch processor for processing said database data in batches.

86. The apparatus of claim 62, further comprising at least one e-mail system for providing said scheduling and said registration configured to communicate with at least one user in a plurality of languages, in a plurality of date formats, in a plurality of calendar types, and in a plurality of time zones.

87. The apparatus of claim 62, further comprising at least one security server comprising an access control component and a password database configured to communicate with at least one user in a plurality of languages, in a plurality of date formats, in a plurality of calendar types, and in a plurality of time zones.

88. The apparatus of claim 87, wherein said access control component further comprises an access database and a login procedure.

89. The apparatus of claim 87, wherein said security server further comprises encrypted data and secure databases for providing secure computer network communications.

90. The apparatus of claim 87, further comprising access permission levels comprising levels of access for accessing data associated with said courses, classes, registering, presenting, and tracking.

91. A computer program product comprising:
computer code to implement an enterprise employee training system comprising computer code configured to:
define at least one global course in a computer system having a memory medium, wherein said computer system further comprises data in a plurality of languages and localized interfaces located in a plurality of continents;
identify a plurality of class presentation languages associated with said global course;
identify a plurality of class location continents associated with said global course;
define at least one class associated with said global course;
register at least one student for said class;
present said class to said students;
track data related to said students' participation in said class.
